(19) United States
(12) Patent Application Publication
(10) Pub. No.: US 2009/0066702 A1
(43) Pub. Date: Mar. 12, 2009

(54) Development Tool for Animated Graphics Application

(76) Inventors: Luc Dion, Montreal (CA); John McCalla, Montreal (CA)

Correspondence Address: GARDERE WYNNE SEWELL LLP;INTELLECTUAL PROPERTY SECTION, 3000 THANKSGIVING TOWER, 1601 ELM ST, DALLAS, TX, 75201-4761, US

(21) Appl. No.: 12/206,185

(22) Filed: Sep. 8, 2008

Related U.S. Application Data
(60) Provisional application No. 60/970,446, filed on Sep. 6, 2007.

(51) Int. Cl. G06T 15/70

(52) U.S. Cl. 345/473

(57) ABSTRACT

A presentation engine collects information concerning the rendering of the frames of an animated graphics application, such the time taken for rendering the frame and the amount of memory used. This information quantifies the amount of certain computing resources being utilized on a per-frame basis, enabling identification by the authors of the animated graphics application, particularly by the designers of the animated graphics, of frames that are problematic, especially on resource-limited devices. The generation of information does not depend on the animated graphics application being instrumented to generate the metrics. The method is adaptable to any resource-limited device, to which the presentation engine is ported or adapted to run. When executing on a resource-limited device, the information is sent to a workstation for analysis. An analysis tool, which may be a stand-alone program or part of an authoring tool or other program, displays the collected metrics graphically in relation to the frame.

### CROSS REFERENCE TO RELATED APPLICATION

This application claims the benefit of provisional application Ser. No. 60/970,446, filed Sep. 6, 2007, the disclosure of which is incorporated herein by reference.

### TECHNICAL FIELD OF THE INVENTION

The present invention relates generally to interaction with an animated graphics presentation engine on a remote, a resource-limited device.

### BACKGROUND OF THE INVENTION

Computer applications are typically written using standard computational programming language, such as C and C++. However, in order to more easily create sophisticated user interfaces and other applications providing rich media content and experiences, developers are turning to the use of graphics-oriented programming languages and platforms for developing rich media applications. These platforms reduce the burden of programming media-intensive interfaces and rich media applications by taking advantage of development tools oriented toward graphics and rich media, and presentation engines that perform much of the graphics processing.

In an application written using animated graphics, a series of static displays are sequentially rendered to create the illusion of animation. Each of these displays will be referred to generally as a “frame.” Examples of such development environments include the Adobe® Flash® development tools, which generate SWF files, and programs written using SVG, which is a language for describing two-dimensional graphics. These applications or files describe graphical elements, text and other elements that are to be rendered, typically using standard vector graphic techniques. They also specify, for each frame, the placement of elements on a “canvas” within the frame. Bit map images, video and audio can also be referenced, placed and displayed or played according to a time line. A “presentation engine” or “player” reads the descriptions of the frames and the graphical elements and renders the frames according to the specified time line, and executes scripts associated with each frame and interaction with a user or the device on which the file is being executed.

For example, the Flash® development environment, which is widely used for creating web-based applications, generates a SWF file that encodes descriptions of the graphical elements, a description of each frame in terms of placement of graphical elements on the canvas for the frame, and any scripts that are to be executed in connection with rendering of the frame or the user's interaction with it. The frames are rendered at a specified frame rate. Similarly, SVG specifies a “document” containing one or more “pages” for display. Each page contains an ordered grouping of graphical elements. Only one grouping is displayed at a time. Animation is created by using Synchronized Multimedia Integration Language (SMIL) to specify timing for rendering each page. Scripts are used to provide interaction with the elements and navigation between the pages.

A rich media application written using an animated graphics format or language—an “animated graphics application” —does not need to be concerned with the details of rendering the graphics and coordinating video and audio, simplifying development and reducing the size of the applications. Scripts can be kept relatively simple by taking advantage of application programming interfaces (APIs) that are implemented by the presentation engines. The APIs typically provide a suite of standard functions, as well as functions for enabling interactivity with the animated graphics and for controlling or interacting with the devices. Developers of applications are thus able to concentrate on the details of the applications, while developers of the presentation engine focus on enhancing playback performance of the presentation engine for particular devices and extending its functionality.

In addition to shortened development and deployment cycles, a further benefit of using animated graphics languages and authoring tools to generate rich media applications is that it allows dividing the task of writing the applications between graphics designers, who use authoring tools to create the graphical portions of the programs, and programmers who write scripts to add functionality and interactively.

Animated graphics applications are particularly well-suited for developing rich media applications running on “embedded systems.” An embedded system is, generally speaking, a special purpose computer system designed to perform certain dedicated functions, which has been embedded into a device. Examples include mobile telephones and other hand-held or mobile devices, and set top boxes for cable and satellite television. Microprocessors or other logic circuits embedded in these devices or equipment are programmed to perform specific functions for the device. Economic considerations dictate that embedded systems have limited processing capability and memory and, at least in the case of mobile devices, smaller screens. Typically, these computing resources are just enough to perform the necessary functions. Resource-limited devices, such as these, are generally not intended to be independently programmable by end users. They sometimes do not permit the user to load additional applications.

Examples of applications that can be written for set top boxes using a graphics language or platform include those that enable users to interact with advanced network services, such as video on demand (VOD) services, digital video recorder (DVR) services, and electronic program guides, as well as games and many other types of applications. Similarly, on a mobile network, a network operator may want to deploy rich media applications, which can be downloaded as required to the mobile device, for allowing easy interaction with services offered by a mobile network, such as, for example, mobile television, music, podcasting, andservices that enable easy access to remote devices and internet-based content.

### SUMMARY OF INVENTION IN ITS PREFERRED EMBODIMENT

The invention pertains generally to tools and methods for analyzing the performance of animated graphics and applications written at least in part using animated graphics. The invention is used to particular advantage in evaluating performance of applications with sophisticated user interfaces, where delay in the performance of the interface is undesirable or unacceptable, and of animated graphics and rich media applications written for execution on resource-limited devices.

Profiling tools used in connection with programs written using traditional languages typically collect execution statistics and information that relate to method and function calls made by the program. This can be done through various techniques, including “instrumentation” of the application, sampling at predetermined intervals, and event notification (such as by a virtual machine running the program). However, these tools and methods are of limited usefulness for analyzing the performance of rich media applications, particularly those written using animated graphics. Collecting information on function calls and methods of the presentation engine provide little useful feedback to an author of an animated graphics application.

A presentation engine employing the teachings of the invention in its preferred embodiment collects information concerning the rendering of the frames of an animated graphics application, such the time taken for rendering the frame and the amount of memory used. This information quantifies the amount of one or more computing resources being utilized on a per-frame basis, enabling identification by the authors of the animated graphics application, particularly by the designers of the animated graphics, of frames that are problematic, especially on resource-limited devices. The generation of information does not depend on the animated graphics application being instrumented to generate the metrics, and therefore may be easily utilized by graphics designers and others who may not have extensive programming capabilities or experience and are often involved with developing animated graphics applications. Furthermore, the method is adaptable to any resource-limited device, to which the presentation engine is ported or adapted to run. When executing on a resource-limited device, the information is preferably sent to a workstation for analysis. An analysis tool, which may be a stand-alone program or part of an authoring tool or other program, preferably displays the collected metrics graphically in relation to the frame.

According to another aspect of the invention in its preferred embodiment, the presentation engine is preferably also capable of collecting performance metrics for scripts that are executed in connection with frame. It may also collect performance metrics for scripts that are executed in response to an input event and system events.

### BRIEF DESCRIPTION OF THE DRAWINGS

FIG. 1 is a schematic diagram representing the basic relationship between a presentation engine, an animated graphics application, and a development tool.

FIG. 2 is flow diagram representing the basic steps of a computer implemented process of a development tool for debugging and profiling animated graphics applications.

FIG. 3 is a flow diagram of one example of a process of using a development tool in connection with the process of FIG. 2.

FIG. 4 is a diagram schematically representing a user interface of a software implemented tool for analyzing the performance of animated graphics applications.

FIG. 5 is a schematic diagram representing certain computer processes and files on a workstation and a remote, resource-limited device.

FIG. 6 is a schematic diagram representing hardware components of the workstation and the remote, resource-limited device of FIG. 1.

FIG. 7 is a flow diagram representing a basic process of communicating between a server executing on a workstation and a presentation engine executing on a remote device.

### DETAILED DESCRIPTION

In the following description, like numbers refer to like elements.

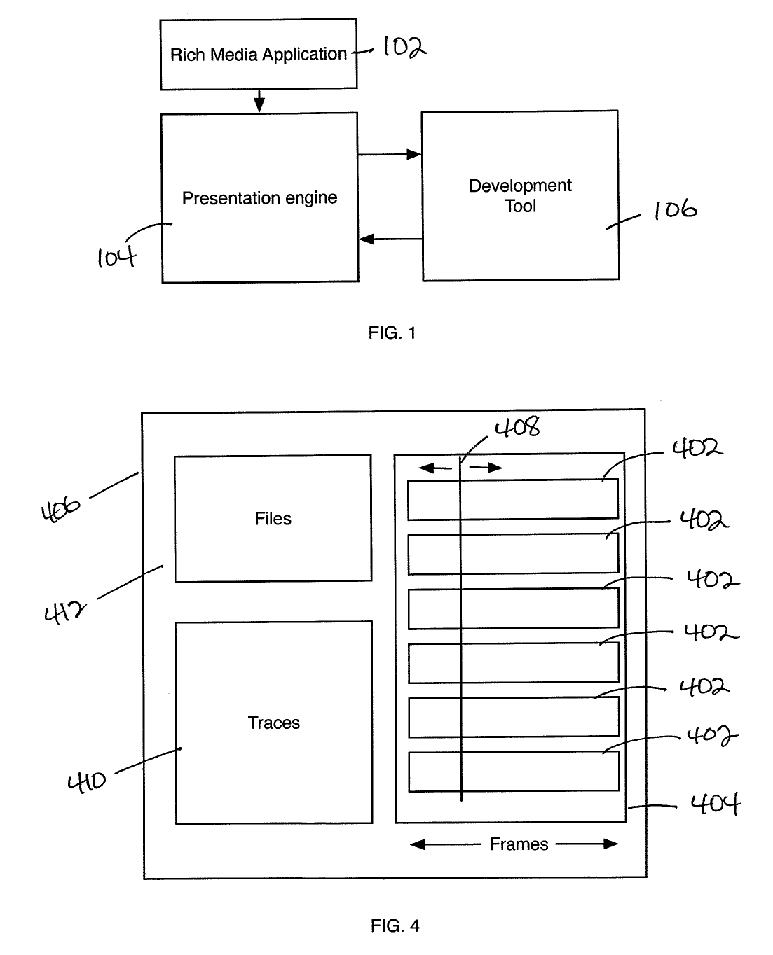

Referring to FIG. 1, animated graphics application 102 is a file that describes, at least in part, its user interface using animated graphics. Current examples of these languages and platforms include the SVG graphics language and Adobe® Flash®. However, animated graphics languages and platforms are not limited to these examples, and include any type of language or platform in which user interfaces are programmed by specifying placement and movement of graphical objects. The application likely also includes scripts that enable, for example, user interactivity with the application, control over animation (such as starting and stopping it, jumping to other frames and other similar functions), retrieval and processing of data, and many other functions.

Presentation engine 104 represents a collection of software-implemented processes running on a microprocessor, which read the descriptions of the graphics animation in the application file and render the graphics. These processes can be implemented with code that is part of a computer program or bundle of computer programs dedicated to this purpose, or as part of another program or collection of programs that provide additional functionality. No particular implementation is implied. Furthermore, the presentation engine preferably also includes, or is set up to work with, a script engine for processing scripts in the application and an application programming interface (“API”) that can be accessed by the scripts. The API preferably also implements functions and methods that are useful for executing rich media applications and that provide access to features or capabilities specific to the device on which the presentation engine is running. The presentation engine may also be distributed with decoders for different types of media resources that may utilized by the application, such as decoders for video, bit mapped images and sound. However, the presentation engine can be configured to make use of other decoding libraries.

Current examples of implementations of the presentation engine 104 include, but are not limited to, the MachBlue™ presentation engine distributed by Bluestreak Networks, Inc. of Montreal, Canada and the Flash® and Flash Lite® players of Adobe Systems, Inc. The MachBlue™ presentation engine is designed to run as middleware on embedded systems with limited processing power and memory, such as set top boxes for cable and satellite television and similar devices. The MachBlue presentation engine interprets and renders files encoded according to the SWF file format (though it does not support rendering of all features of Flash® authoring environment) as well as certain extensions to the SWF file format adapted for specific devices.

The presentation engine preferably includes processes that measure, or that collect information to enable measurement by other processes not included in those of the presentation engine, certain metrics concerning the presentation engine's rendering of the animated graphics described by the application and associated scripts. The collected information is then reported to another set of processes for analysis by the developer. This other set of processes will be referenced as development tool 106 for analysis. The development tool can be comprised of a computer program dedicated to collection, storage and analysis of the information, or as a plug-in to another type of development tool. The processes can also be implemented directly by other types of development tools, including authoring tools such as Adobe® Flash®. No particular implementation should be implied or foreclosed by references to the development tool.

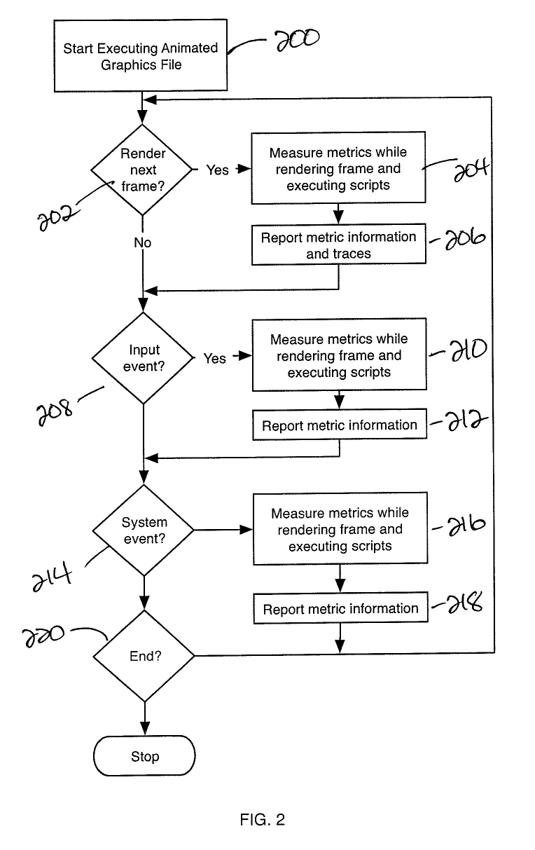

Illustrated in FIG. 2 are the basic steps of a process of collecting performance metrics for an animated graphics application based on the occurrence of a frame rendering event, an input event and a system event. The process assumes that the presentation engine has been configured to generate at least one metric. Collection of all of the metrics it might otherwise be capable of generating need not be enabled. Metrics could include, but are not limited to, one or more of the following: total memory allocated to executing application; time to execute frame, time to render graphics for entire frame or just part of frame; script execution time for frame; total memory used by application; count of script objects; count of graphics objects drawn during frame; count of movie clips; count of buttons; count of text fields; and count of shapes. The metrics include or are generated using, for the most part, information that a presentation typically keeps track of, or that can be easily calculated from what a presentation engine keeps track of, when executing an animated graphics application. These metrics impact performance of an animated graphics application but are not easy to perceive from the display of the application. For example, object counts allow a designer to find graphical objects that are not visible (perhaps because they are fully occluded by other elements). These objects are “dead weight” and can be eliminated.

The presentation engine begins executing the animated graphics file at step 200. If it is time to render a frame, as indicated by step 202, the presentation engine renders the frame, executes any scripts associated with the frame, and measures specified metrics at step 204. The term measure is intended to refer to any gathering or generation of information relating to a specified metric, and need not include all steps necessary for calculating a final result unless specifically stated otherwise. The term “metrics” in this description is intended to refer to not only the final value for the metric, but also any information collected by the presentation engine for calculation of the metric. The metrics are then reported at step 206. If, as indicated by step 208, an input event occurs, the presentation engine also measures any specified metrics applicable to the script or scripts and any graphic renderings associated with the event at step 210, and reports them at step 212. An input event may include a user pressing a key or selecting a button or other graphic. When a system event occurs, as indicated by step 214, metrics associated with rendering graphics and executing the scripts that are occurring in response to the event are measured at step 216 and reported at step 218. System events include, for example, backlight on/off, changes in network state, power input on/off, and loading of resource files. If the application has not ended at step 220, the process loops back to step 202. The loop formed by decision steps 202, 208, 214 and 220 is intended to represent an event-driven process. Reporting of a metric may include writing the information to a file, or transmitting in real time or on a delayed basis the metric in a message sent to another program, such as development tool 106. Any traces embedded in the application and encountered during rendering of the frame or execution of scripts are also reported.

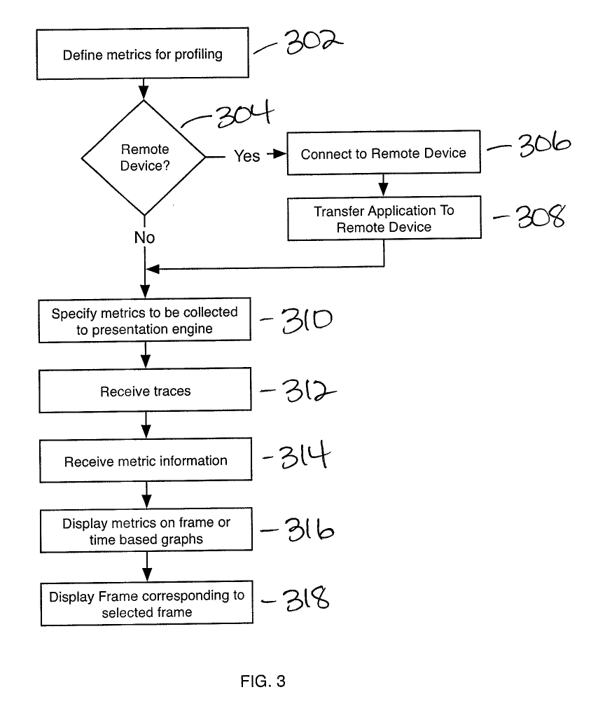

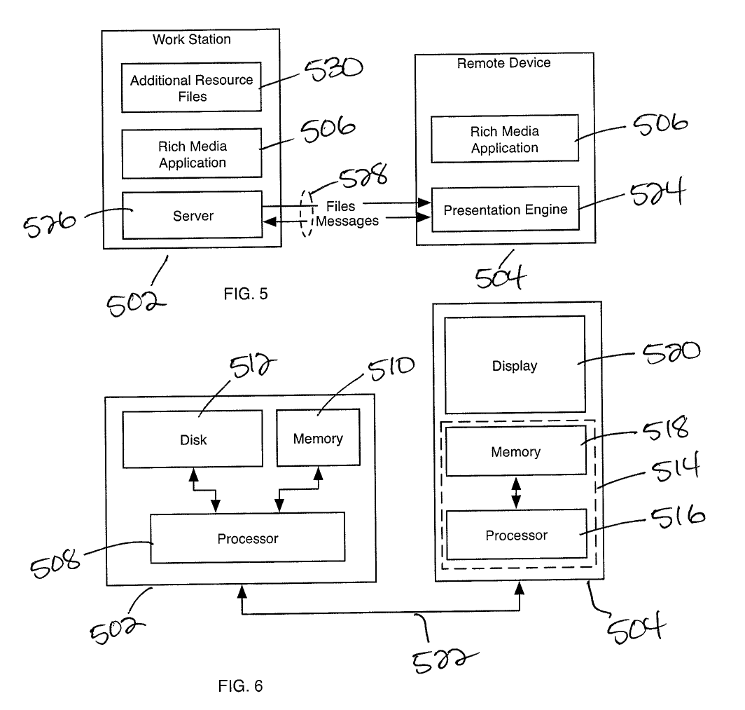

FIG. 3 illustrates a representative process of using a development tool 106 (FIG. 1) to collect metrics. The development tool is, as indicated at step 302, used to define the metrics to be measured and collected. If the presentation engine that will be executing the animated graphics application is running on a remote device, as indicated by step 304, the development tool connects with the remote device at step 306 and transfers the application to the remote device at step 308 for execution. The development tool also specifies metrics to be collected at step 310. Steps 308 and 310 can be performed in reverse order. The development tools receives any trace messages embedded in the application and the measured metrics at steps 312 and 314. The order in which traces and metrics are received is immaterial. As previously mentioned, traces and/or performance metrics information is preferably sent in messages on a per-event basis (either in real time or delayed). When the application is executing on a resource-limited device, doing so avoids having to store the information on the remote device, which may effect performance. However, the metrics can also be sent in batches during execution, or in one or more files at the end of the execution of the application. The details of connecting to the remote device, and communicating with the remote presentation engine are described in connection with FIGS. 5-7.

Referring now also to FIG. 4 in addition to FIG. 3, once the metrics are made available to the development tool, the metrics are displayed on one or more graphs 402 in a window 404 in the application window 406 of the development tool on a computer display 400, as indicated by step 316. Each graph preferably displays the value of the metric on a frame or time basis, with the x-axis indicating the frame or time and the y-axis indicating the value of the metric for the particular frame. However, multiple metrics can be displayed on the same graph. As indicated by step 318, cursor 408 is used to select a frame. Numerical values for the metrics of a frame selected by the cursor are displayed in fields (not shown) adjacent to the graphs. Traces are displayed in window 410. File names for the animated graphics applications are shown in window 412. Profiles for different applications can be stored and displayed.

Referring to FIGS. 5 and 6, collecting performance metrics is particularly useful for development of animated graphics applications intended to run on resource-limited devices. FIG. 5 schematically represents software-implemented processes and files on a workstation 502 and resource-limited remote device 504. FIG. 6 schematically represents the hardware for storing and executing software program instructions for performing the processes. Animated graphics application 506 is stored on general purpose computer workstation 502. The workstation includes a processor 508, memory 510 for temporary storage of executing programs and data, and one or more disks 512 for storage of program and data files. The workstation is coupled to a remote device 504. Examples of the remote device include, but are not limited to, a set top box and a mobile, hand-held device with wireless communication capabilities, for example a cellular telephone or device with “Wi Fi” capabilities. The remote device includes a resource-limited embedded system 514 comprised of a central processing unit 516 for executing program instructions and files stored in memory 518. The device will also have additional elements relating to the particular purpose of the device. For example, if the device is a satellite or cable set top box, it would also include a tuner and interfaces for video and audio. In the illustrated example, the device includes a display 520, such as would be typically found on a mobile telephone. Memories 510 and 518 are intended to represent memory generally and are not intended to represent any particular memory structure. For example, memory in an embedded system will depend on the purpose of the system, but it typically will include some type of memory for long term storage (typically non-volatile) and working memory for use by the processor in storing program code and data.

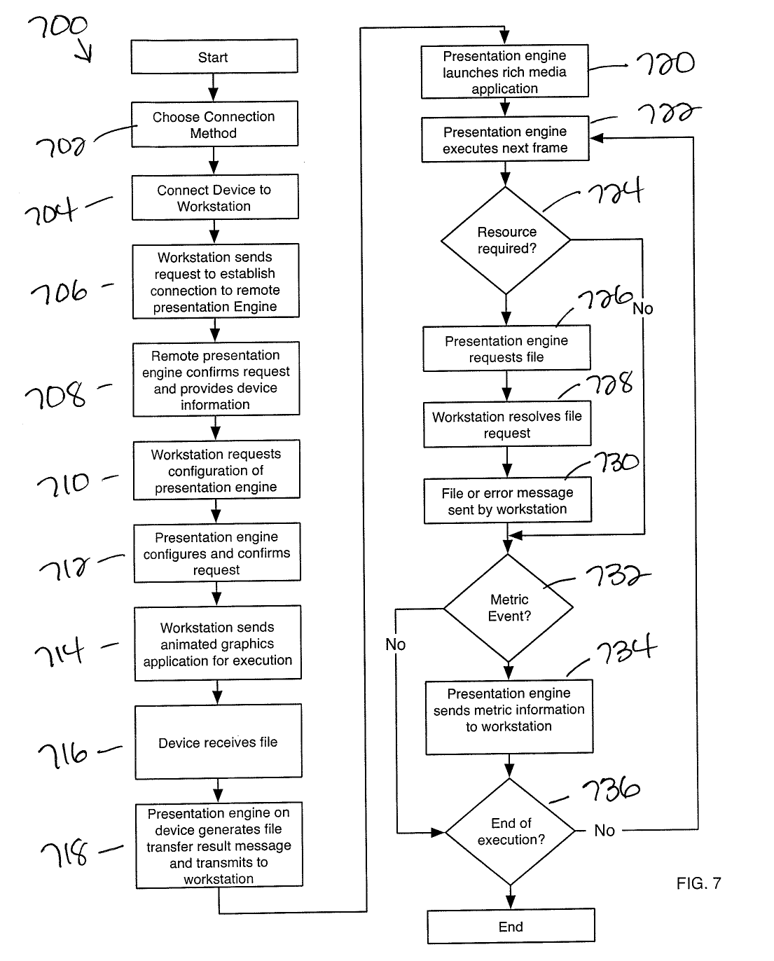

The workstation 502 and remote device 504 are coupled through a physical communications channel 522. This communications channel is comprised of one or more links. Each link could be comprised of, for example, a wired or wireless connection. Examples of wired connections include serial, USB, and Ethernet connections. Examples of wireless connections include Bluetooth, wireless local or metropolitan area network connections (IEEE 802.11 or 802.16, for example), and cellular telephone and data networks. A presentation engine 524 for executing or playing animated graphics files on a resource-constrained remote device is loaded on remote device 504. Communication server processes 526 executing on workstation 12 establish an application-level communication session 528 with presentation engine 524 over the physical communications channel 30. The server processes are further comprised of processes for enabling exchanging information with the presentation engine, including requests that control operation of presentation engine, such as by configuring its execution, and exchanging of files. The server processes pass information to and from other applications that are running of the workstation, which want to communicate with the presentation engine. For example, authoring applications or other development tools such as debugging tools can utilize the communications facility. These applications could be implemented to include the sever processes, in whole or in part, or by utilizing plug-ins that provide these services. Alternately, these processes can be implemented as a independent application. The presentation engine either includes, or is configured to utilize, software for establishing the communication session and exchange communications with the server. The communications server processes for establishing and using the communication session is preferably implemented so that it is independent of the underlying physical connection between a workstation and the remote device. Resource limited devices come in many different varieties and have different capabilities for connecting to computers and networks. For example, some set top boxes support Ethernet connections and many mobile telephones do not. Mobile telephones may, on the other hand, support Bluetooth wireless connections. The software program implementing the server processes, such as for example an authoring tool or debugging tool, preferably includes mechanisms or processes for configuring different types of communications links between a workstation and the resource limited device, over which the communications with the presentation engine may take place. A representative example of a process flow 100 utilizing the communication between the presentation engine 524 and the server 526 is illustrated by the flow chart of FIG. 7. Referring also to FIG. 7, in addition to FIGS. 5 and 2, the representative process 700 starts with selection of a communications method at step 702. The server processes 526 preferably assist with configuring or setting up the physical connection with the remote device, depending on the type of device. For example, if it is a TCP/IP connection using Ethernet interfaces at the workstation and the remote device, the application implementing the server processes can be used to enter and store IP addresses for the connection. If the remote device is a cellular telephone, for example, the connection may use a Bluetooth wireless connection. The server processes could store profiles for different remote devices. Another example that can be used for Windows CE based devices is ActiveSync USB connection. Once the connection method is chosen and any configuration information not previously stored is entered, the server software initiates setting up the physical connection to the remote device at step 704 over the physical communications channel 522. The connection depends on the software and hardware installed on workstation and remote device, to which the server software has access. Alternately, the connection may be set up manually.

At step 706, the server software sends, over the established communication link, a request for connection to the presentation engine 524 on the remote device. The remote presentation engine 524 confirms the request by sending back certain information that identifies the device and details of the presentation engine at step 708. This establishes a communication session with the presentation server. The remaining steps in the flow chart are illustrative only, and can be performed out of order, depending on the purpose to which the communication facility is put.

For example, the workstation at step 710 transmits a request to the presentation engine to configure itself for collection of performance metric information. The request preferably includes a list of metrics to collect. The presentation engine would then turn on metric measurement services prior to executing a rich media application. The presentation engine configures itself at step 712 and confirms the request to the server.

The workstation sends at step 714 a rich media application file to the device for execution, and at step 716 the remote device 504 receives the file. The presentation engine 524 acknowledges that the file has been successfully transferred by sending a message to the server 526 at step 718.

The presentation engine then, as indicated by step 720, launches execution of the rich media application. In this example, the application is written as a frame-based animated graphics movie comprised of a sequences of frames. The next frame, or the first frame if there was no previous frame, is executed by the presentation engine at step 722.

When executing the application, the presentation engine may determine that it needs a resource referenced in the file, for example, a bitmap image such as a JPEG file or a XML file containing data, that is not stored on the remote device but rather on the remote host. The application might only specify the name of a file, and not a URL identifying the location of the file on the host or an otherwise fully qualified path to a directory on a host where the file can be found. The presentation engine is preferably enabled to send to the workstation, at step 726, a request for a resource file 530 on the workstation that it does not have and that is required for rendering of the frame or executing a script associated with the frame. When the request is received by the workstation sever, the server assumes at step 728 that the file is located in the same directory as the rich media application 506 and transfers this file to the remote device at step 730 if it is found. If the file is not found, an error message is sent. This capability allows local resource references to be maintained in the application during development without having to download all resources to the device in connection with testing or include in the application a URL to the file on the workstation host.

At step 732, if the presentation engine has been configured to generate metrics and/or send traces, it will send to the server on the workstation at step 734 the information on the metrics or traces upon the occurrence of frame, input and/or system event, as described in connection with FIG. 2. Steps 722 to 734 are repeated until the application ends or is stopped, as indicted by decision step 736.

The following is an illustrative example of a transfer protocol for implementing a preferred embodiment of communications facility for purposes of assisting with debugging and profiling of an animated graphics application being executed by a presentation engine on a remote device, and is not intended to limit the general concepts expressed above.

Data sent between a workstation and a remote device is packaged in a packet. A packet corresponds to either a message (no results are returned) or a request (a result is returned). This is controlled by a flag in all packets that indicates if a result must be returned by the receiver. A packet contains two parts: a packet header and packet data or payload. The packet header includes information on the size of the data part of the packet, a validation field and a CRC field for checking data integrity. The payload depends on the type of packet. The packet data comprises what will be termed generically below as a “request,” even though the request may actually constitute a message if no results is expected.

A request header includes one or more of the following types of information: a identifier of the type of packet, for example a trace, a file transfer, or a device information request; the size of the request; a unique request unique identifier; an application identifier that identifies a running animated graphics application file; and flags that affect the handling of the request. For example, a flag can be set to indicate that a result must be returned by the request receiver to indicate the request completion result.

Following are examples of request types for implementing this example.

An “Establish Connection” request is sent by a newly connected client to notify the server on the workstation that it is now waiting for requests. The servers send the request. The remote client responds by sending a “Device Info” request.

A “Device Info” request is sent by the client on the remote device to give information on the presentation engine and device to the newly connected client. This request is sent immediately after an Establish Connection request is received. The request preferably includes, for example, the protocol version, which indicates the device supported version of communication protocol, the device platform type, which identifies the hardware/software platform on which the presentation engine is running, and the version of the presentation engine.

A “Result” request sends the result of a received request. It preferably contains a unique identifier of the received request and the requested result.

A “File Transfer” request is used to send a file to the remote client. It preferably includes the name of the file, its size, and the actual file content, and a flag to indicate whether the file must be executed or launched by the presentation engine.

Additional requests can be structured to configure the presentation engine and to request and receive additional information from the presentation engine, which in this example is information about the execution of the animated graphics application by the presentation engine.

A “Trace” request is used by the presentation engine client to send a SWF trace. It includes an indication of the type of encoding used for the data string, for example ANSI, UCS2, UCS4, etc., the size of the data string, and the actual data string containing the trace information.

A “Frame Info” request is used to transmit metrics about the execution of a frame of the animated graphics application. The metrics is packaged as a list of value-pairs. Each value-pair includes an identifier of the metric, for example, the time it took to render the frame, the amount of memory used, the time it took to execute scripts associated with the frame, etc., and a data value.

To configure the remote presentation engine, the server on the workstation sends a Configuration request. The Configuration request specifies in its data part a list of metrics to calculate and return after execution of each frame is completed. This request is preferably sent immediately after the connection is established with a remote device.

The foregoing description is of exemplary and preferred embodiments of methods and tools for use in analyzing performance of animated graphics. The invention is not limited to the described examples or embodiments. Alterations and modifications to the disclosed embodiments may be made without departing from the invention. The meaning of the terms used in this specification are, unless expressly stated otherwise, intended to have ordinary and customary meaning and are not intended to be limited to the details of the illustrated structures or the disclosed embodiments. None of the foregoing description is to be read as implying that any particular element, step, or function is an essential element which must be included in the claim scope. The scope of patented subject matter is defined only by the issued claims. None of these claims are intended to invoke paragraph six of 35 USC §112 unless the exact words “means for” or “steps for” are followed by a participle.

What is claimed is:

1. A computer implemented method for analyzing performance of animated graphics applications executing in a programmable computing system, the computing system comprising a microprocessor and memory, the method comprising:
rendering sequentially, with the computer, a plurality of graphical frames described in an animated graphics application file, each of the plurality of graphic frames comprised of one or more graphical objects;
executing with the computer at least one script associated with the rendering of at least one of the plurality of the frames at the time of the rendering of the frame;
measuring with the computer at least one performance metric associated with rendering one of the plurality of graphic frames, one of the at least one performance metrics chosen from a group consisting of time to execute a frame, time to render graphics, script execution time, total memory used by application, count of graphic objects in memory, count of graphic objects drawn during a frame, and count of shapes; and
reporting with the computer the measured at least one performance metric.

2. The method of claim 1, wherein the computer is comprised of a microprocessor and memory embedded in a device, the device chosen from a group consisting of a mobile wireless communication device, a mobile telephone, a satellite set top box, or a cable set top box.

3. The method of claim 1, wherein reporting comprises storing the measured at least one performance metric in memory of the computer.

4. The method of claim 1, wherein reporting comprises communicating the measured at least one performance metric to a remote computer.

5. The method of claim 4 wherein the remote computer displays for each of the plurality of frames, values of the reported at least one performance metric on a frame-based graph.

6. The method of claim 4 wherein the the remote computer displays for each of the plurality of frames values of the reported at least one performance metric on a time-based graph.

7. The method of claim 1, further comprising specifying on a remote computer the at least one performance metric to be measured and transmitting an identification of the at least one performance metric to the computer rendering the plurality of frames.

8. The method of claim 1, wherein rendering sequentially the plurality of frames is comprised of rendering at least one of the plurality of frames according a time line.

9. The method of claim 1, wherein rendering sequentially the plurality of frames is comprised of rendering at least one of the plurality of frames in response to an input event.

10. The method of claim 1, wherein rendering sequentially the plurality of frames is comprised of rendering each of the plurality of frames in response to an event generated by a device in which the computer is embedded.

11. The method of claim 1, wherein the plurality of frames are sequentially rendered according to a time line, in response to an input event, and in response to an event generated by a device in which the computer is embedded.

12. Computer readable medium storing program instructions for execution by a processor, the program instructions comprising instructions for:
rendering sequentially a plurality of graphical frames described in an animated graphics application file, each of the plurality of graphic frames comprised of one or more graphical objects;
executing at least one script associated with the rendering of at least one of the plurality of the frames at the time of the rendering of the frame;
measuring at least one performance metric associated with rendering one of the plurality of graphic frames, one of the at least one performance metrics chosen from a group consisting of time to execute a frame, time to render graphics, script execution time, total memory used by application, count of graphic objects in memory, count of graphic objects drawn during a frame, and count of shapes; and
reporting the measured at least one performance metric.

13. The computer readable medium of claim 12, wherein reporting comprises storing the measured at least one performance metric in memory of the computer.

14. The computer readable medium of claim 12, wherein reporting comprises communicating the measured at least one performance metric to a remote computer.

15. The computer readable medium of claim 14 wherein the the remote computer displays values of the reported at least one performance metric on a frame-based graph.

16. The computer readable medium of claim 14 wherein the the remote computer displays of the reported at least one performance metric on a frame-based graph.

17. The computer readable medium of claim 12, further comprising specifying on a remote computer the at least one performance metric to be measured and transmitting an identification of the at least one performance metric to the computer rendering the plurality of frames.

18. The computer readable medium of claim 12, wherein rendering sequentially the plurality of frames is comprised of rendering each of the plurality of frames according a time line.

19. The computer readable medium of claim 12, wherein rendering sequentially the plurality of frames is comprised of rendering at least one of the plurality of frames in response to an input event.

20. The computer readable medium of claim 12, wherein rendering sequentially the plurality of frames is comprised of rendering at least one of the plurality of frames in response to an event generated by a device in which the computer is embedded.

21. The computer readable medium of claim 12, wherein the plurality of frames are sequentially rendered according to a time line, in response to an input event, and in response to an event generated by a device in which the computer is embedded.

22. An embedded device comprising a microprocessor and memory, and further comprising,
means for rendering sequentially a plurality of graphical frames described in an animated graphics application file, each of the plurality of graphic frames comprised of one or more graphical objects;
means for executing at least one script associated with the rendering of at least one of the plurality of the frames at the time of the rendering of the frame;
means for measuring at least one performance metric associated with rendering one of the plurality of graphic frames, one of the at least one performance metrics chosen from a group consisting of time to execute a frame, time to render graphics, script execution time, total memory used by application, count of graphic objects in memory, count of graphic objects drawn during a frame, and count of shapes; and
means for reporting the measured at least one performance metric.

23. The embedded device of claim 22, wherein the means for reporting comprises storing the measured at least one performance metric in memory of the computer.

24. The embedded device of claim 22, wherein reporting comprises means for communicating the measured at least one performance metric to a remote computer.

25. The embedded device of claim 24 wherein the remote computer displays values of the reported at least one performance metric for on a frame-based graph.

26. The embedded device of claim 24 wherein the remote computer displays values of the reported at least one performance metric on a time-based graph.

27. The embedded device of claim 22, further comprising specifying on a remote computer the at least one performance metric to be measured and transmitting an identification of the at least one performance metric to the computer rendering the plurality of frames.

28. The embedded device of claim 22, wherein rendering sequentially the plurality of frames is comprised of rendering each of the plurality of frames according to a time line.

29. The embedded device of claim 22, wherein rendering sequentially the plurality of frames is comprised of rendering at least one of the plurality of frames in response to an input event.

30. The embedded device of claim 22, wherein rendering sequentially the plurality of frames is comprised of rending each of the plurality of frames in response to an event generated by a device in which the computer is embedded.

31. The embedded device of claim 22, wherein the plurality of frames are sequentially rendered according to a time line, in response to an input event, and in response to an event generated by a device in which the computer is embedded.

32. A method of evaluating the performance of an animated graphics application being rendered by a presentation engine executing on a remote device, the animated graphics application describing a user interface as a plurality of graphic frames to be sequentially rendered and including at least one a program script associated with at least one of the plurality graphic frames; the method comprising:
receiving from the remote device information at least one performance metric associated with rendering one of the plurality of graphic frames by the presentation engine, one of the at least one performance metrics chosen from a group consisting of time to execute a frame, time to render graphics, script execution time, total memory used by application, count of graphic objects in memory, count of graphic objects drawn during a frame, and count of shapes; and
displaying graphically the value of the received at least one performance metric.

33. The method of claim 32 wherein displaying values of the received at least one performance metric comprises displaying values of the received at least one performance metric on a time-line graph.

34. The method of claim 32, wherein displaying values of the received at least one performance metric comprises displaying values of the received at least one performance metric on a frame-by-frame basis on a graph.

35. The method of claim 32, wherein values for a plurality of performance metrics are received from the remote device, and wherein displaying graphically the values of the received at least one performance metric comprises displaying graphically the value of each of the plurality of performance metrics on a per frame basis, each of the plurality of performance metrics being represented on a different graph.

36. The method of claim 32, wherein the values of the at least one performance metric are received upon occurrence of an event in response to which the value is generated.

37. The method of claim 32, further comprising receiving traces generated by the application and displaying the traces on a per frame basis.

38. The method of claim 32, further comprising receiving from a user a specification of metrics to be collected by the presentation engine on the remote device, configuration the presentation engine on the remote device to collect the specified metrics; and transmitting to the remote device the animated graphics application for execution by the presentation engine on the remote device.

39. The method of claim 32, wherein the remote device is comprised of a microprocessor and memory and is chosen from a group consisting of a mobile wireless communication device, a mobile telephone, a satellite set top box, and a cable set top box.
